(19) United States
(12) Patent Application Publication
(10) Pub. No.: US 2009/0250536 A1
(43) Pub. Date: Oct. 8, 2009

(54) ATM Card Shredder

(76) Inventor: Francella Henderson, Inglewood, CA (US)

Correspondence Address: WEST & ASSOCIATES, A PC, 2815 MITCHELL DRIVE, SUITE 209, WALNUT CREEK, CA, 94598, US

(21) Appl. No.: 12/419,079

(22) Filed: Apr. 6, 2009

Related U.S. Application Data
(60) Provisional application No. 61/042,609, filed on Apr. 4, 2008.

(51) Int. Cl. B02C 19/00; B02C 23/00

(52) U.S. Cl. 241/100; 241/264

(57) ABSTRACT

A credit card shredding device for use in automated teller machines (ATMs) that can cut stolen bank cards into crosscut pieces.

### CLAIM OF PRIORITY

The following application claims priority to U.S. Provisional Patent Application No. 61/042,609, filed Apr. 4, 2008, the complete contents of which are hereby incorporated by reference.

### BACKGROUND

1. Field of the Invention

The present disclosure relates to the field of bank security devices, specifically an ATM card shredder that cuts a credit or debit card into crosscut pieces when it is detected that the card is stolen.

2. Background

In our modern society, automated teller machines (ATMs) are the primary means by which one takes money out of a personal bank account. However, in the absence of face-to-face interaction with a live bank teller, who can verify the identity of a person withdrawing money, the chance of an unauthorized user succeeding in taking cash from someone else's account increases. Currently, most ATMs are able to detect when a reportedly stolen card has been inserted in the machine. Upon detection, an ATM equipped with a manual card reader retains the stolen card and does not allow the unauthorized user to access the bank account linked to the card. The retained card is usually dropped into a bin within the ATM, but it is still possible for the card to be stolen from the bin either by an employee of the financial institution operating the ATM or by other persons who damage the ATM and gain access.

Some ATMs are equipped with dip readers instead of manual card readers. In contrast to a manual card reader, which does not return a bank card until the user is finished with all transactions, a dip reader enables a user to quickly insert and remove a card before proceeding with any transactions. For purposes of security and preventing illegal transactions, though, this method is undesirable because even if the ATM recognizes that a card is stolen, the unauthorized user can still hold on to the card and possibly use it at other ATMs or for making purchases elsewhere.

Therefore, what is needed is a device for installation in a manual card reader-equipped ATM which can shred a stolen bank card into pieces such that it can no longer be used. It is further desirable for the shredding device to be capable of cutting a bank card in a crosscut fashion, thereby preventing someone from successfully gluing the card back together or obtaining the card number.

### BRIEF DESCRIPTION OF THE DRAWINGS

FIG. 1 depicts a side cross-section view of the present device in an open configuration prior to receiving a bank card.

FIG. 2 depicts a side cross-section view of the present device in a closed, in-use configuration.

FIG. 3 depicts a side cross-section view of the present device in an open-jaw configuration after cutting a bank card.

FIG. 4 depicts a top view of one embodiment of the cutting plates of the present device.

FIG. 5 depicts a perspective view of an alternate embodiment of the present device.

FIG. 6 depicts a perspective view of one embodiment of a cut bank card.

### DETAILED DESCRIPTION

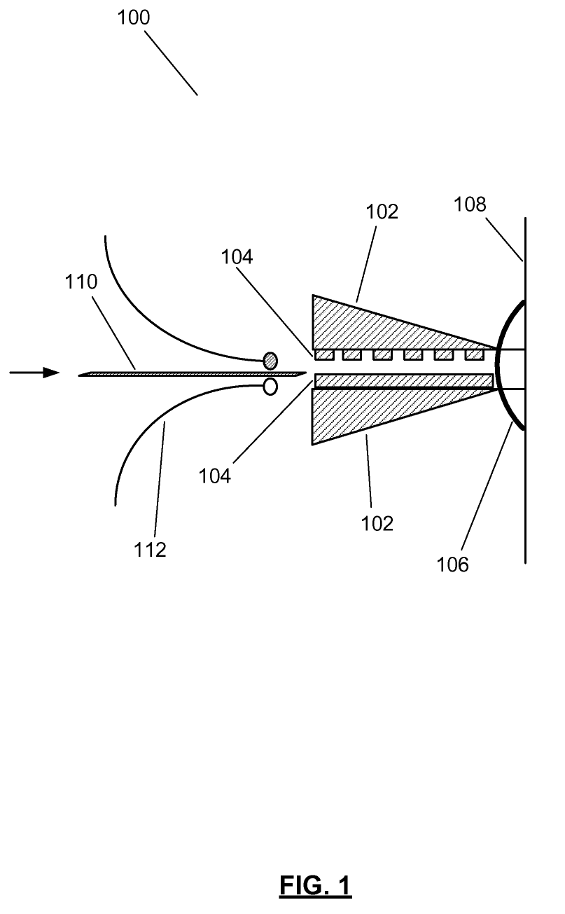

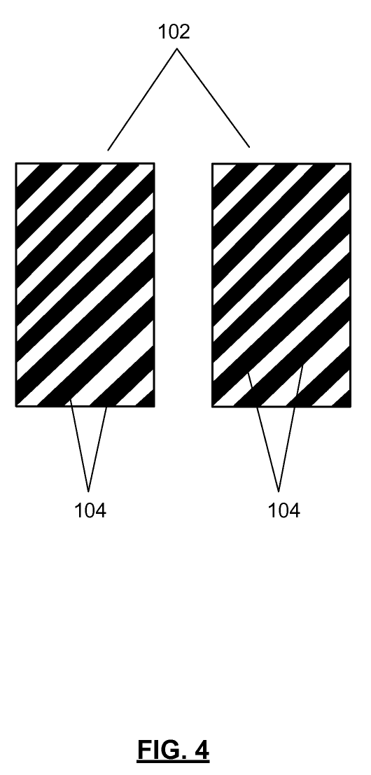

FIG. 1 illustrates a side cross-section view of a shredding device 100 in an open position. A shredding device 100 can have at least two plates 102, each plate having interior and exterior surfaces. The interior surface of plates 102 can be substantially parallel to each other and can have a space between them when a shredding device 100 is in a position ready to accept a bank card 110. The interior surface of at least one plate 102 can be coupled with a set of cutting blades 104. As shown in FIG. 4, plates 102 can each have a set of cutting blades 104 positioned along their respective interior surfaces such that when the interior surfaces face each other, each set of cutting blades 104 can be oriented in opposing directions.

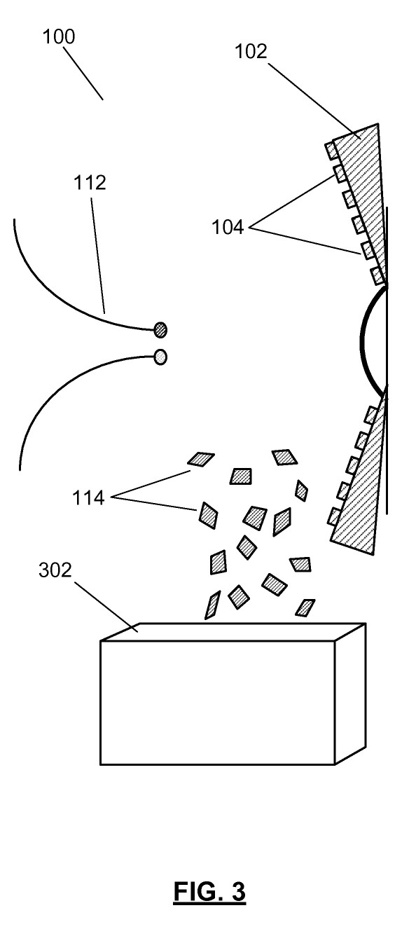

Referring back to FIG. 1, plates 102 can be coupled with a stationary surface 108 within an ATM via at least one hinge mechanism 106, such that plates 102 can move toward and away from a central plane between plates 102. A shredding device 100 can be coupled with the interior of an ATM such that when a bank card 110 is fed through a manual card reader 112, a shredding device 100 can receive the bank card 110 if the ATM's computer system determines it is stolen. A shredding device 100 can further comprise a disposal bin 302, as shown in FIG. 3, coupled with or proximate to plates 102.

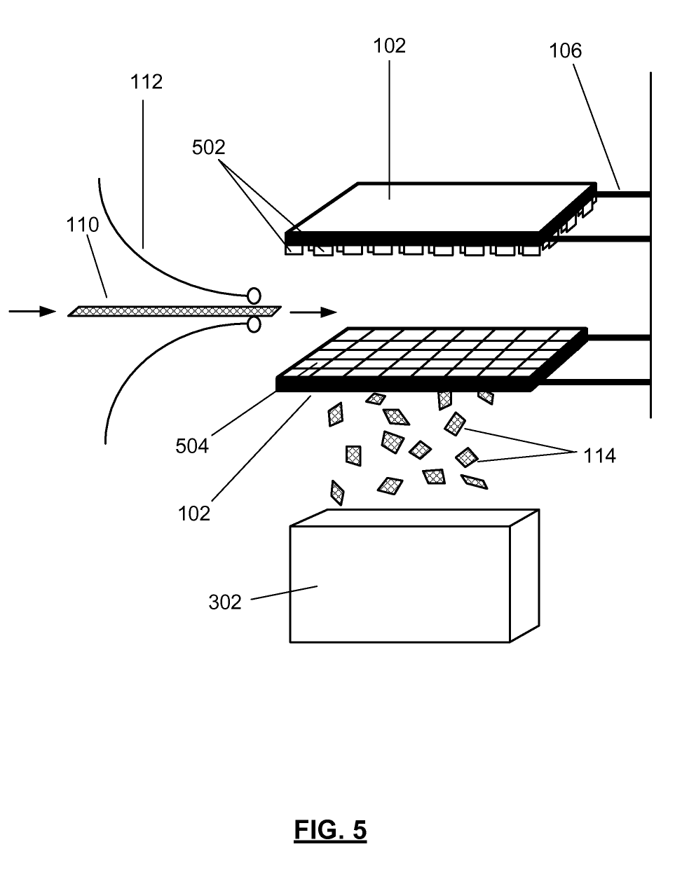

Plates 102 can be made of metal, ceramic, or any other known and/or convenient material with sufficient strength and durability to support sets of cutting blades 104. Although plates 102 are depicted as wedges (FIG. 1) and cuboids (FIG. 5), plates 102 can have any other known and/or convenient geometry. Sets of cutting blades 104 can be made of metal, ceramic, or any other known and/or convenient material with sufficient strength and durability to cut through bank cards. In some embodiments, at least one set of cutting blades 104 can be coated with Teflon®, ceramic, titanium alloys, or any other known and/or convenient material for providing strength, durability, and/or increased life of the blades 104. In FIG. 4, cutting blades 104 are positioned in diagonal orientations, but in other embodiments cutting blades 104 can have any other known and/or convenient orientation such that a bank card 110 can be cut into crosscut pieces 114 (as shown in FIG. 3).

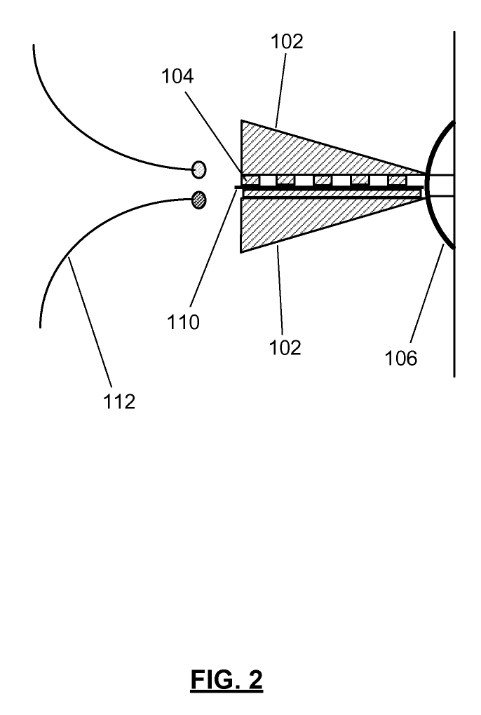

FIG. 2 depicts a side cross-section view of a shredding device 100 in a closed, in-use position. In use, the computer system of a manual card reader 112 can determine whether a bank card 110 is stolen and whether it should be retained and shredded by a shredding device 100. After determination that a bank card 110 should be cut, a shredding device 100 can receive the bank card 110 via a manual card reader 112, as shown in FIGS. 1,2. Plates 102 can then move toward each other while remaining substantially parallel, via at least one hinge mechanism 106. Plates 102 can move toward each other such that each set of cutting blades 104 can be in contact with a bank card 110. Thereafter, blades 104 can apply force to the bank card 110 such that the bank card 110 can be cut into crosscut pieces 114, as shown in FIG. 3.

Referring to FIG. 5, in an alternate embodiment a shredding device 100 can comprise an upper plate 102 and a lower plate 102, positioned substantially parallel to each other and in substantially horizontal positions. The interior surface of an upper plate 102 can be coupled with a plurality of protrusions 502. A lower plate 102 can have a blade grid 504, wherein the lines of the blade grid 504 can be oriented orthogonally to each other and to the edges of a lower plate 102. In alternate embodiments, a blade grid 504 can have any other known and/or convenient orientation. Protrusions 502 can be made of metal, ceramic, polymer, glass, or any other known and/or convenient material with sufficient strength to withstand the force required to push a bank card 110 through a blade grid 504. A blade grid 504 can be made of metal, ceramic, or any other known and/or convenient material adapted to cut through a bank card 110.

In use, the shredding device 100 in FIG. 5 can receive a bank card 110. An upper plate 102 can move toward a stationary lower plate 102 such that protrusions 502 can press a bank card 110 against a blade grid 504 of the lower plate 102. The upper plate 102 can exert force on a bank card 100 such that it is forced through a blade grid 504, thereby cutting the bank card 110 into crosscut pieces 114. Crosscut pieces 114 can subsequently fall through a lower plate 102 and into a disposal bin 302.

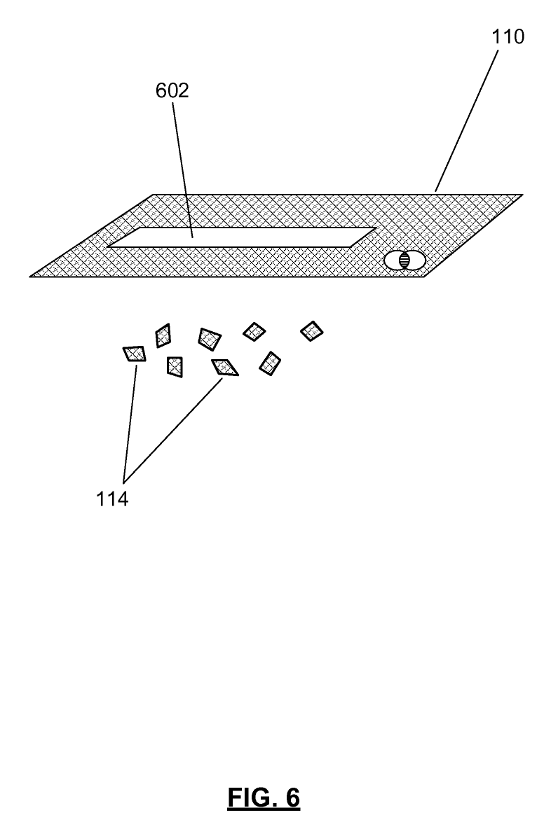

In some embodiments, a shredding device 100 can be designed to cut a bank card 110 only partially. As shown in FIG. 6, a shredding device 100 can cut out a portion 602 of a bank card 110 that contains important numbers, such as a card or account number. This portion 602 can be cut into crosscut pieces 114, as shown.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A bank card shredding device, comprising:
first and second plates each having at least one substantially planar surface;
said first plate having a first set of blades coupled with and perpendicular to said substantially planar surface of said first plate;
wherein said first and second plates are operatively coupled via at least one hinge mechanism;
wherein said at least one hinge mechanism is coupled with a stationary surface.

2. The device of claim 1, further comprising a second set of blades coupled with said substantially planar surface of said second plate.

3. The device of claim 2, wherein said first and second sets of blades protrude from said substantially planar surfaces of said first and second plates such that when said substantially planar surfaces are parallel to and facing each other, said first and second sets of blades run in substantially opposite directions.

4. The device of claim 1, further comprising a disposal bin substantially underneath said first and second plates for receiving bank card pieces.

5. The device of claim 1, wherein said second plate is joined to a plurality of protrusions on said substantially planar surface of said second plate.
